(19) United States
(12) Patent Application Publication
(10) Pub. No.: US 2024/0168309 A1
(43) Pub. Date: May 23, 2024

(54) DISPLAY DEVICE

(71) Applicant: Japan Display Inc., Tokyo (JP)

(72) Inventor: Shuji Hayashi, Tokyo (JP)

(21) Appl. No.: 18/509,009

(22) Filed: Nov. 14, 2023

(30) Foreign Application Priority Data
Nov. 22, 2022 (JP) 2022-186412

(51) Int. Cl. G02B 30/27; G02B 30/30

(52) U.S. Cl. CPC G02B 30/27; G02B 30/30

(57) ABSTRACT

According to one embodiment, a display device includes a lens element including a plurality of lenses, a barrier element including a plurality of light-shielding layers and a display panel, and the lens element is provided between the display panel and the barrier element, each of the plurality of light-shielding layers overlaps an end portion of each respective one of the plurality of lenses. When the region between each adjacent pair of the light-shielding layers is an aperture, the barrier element has a plurality of apertures.

### CROSS-REFERENCE TO RELATED APPLICATIONS

This application is based upon and claims the benefit of priority from Japanese Patent Application No. 2022-186412 filed Nov. 22, 2022, the entire contents of which are incorporated herein by reference.

### FIELD

Embodiments described herein relate generally to a display device.

### BACKGROUND

In recent years, various display devices which enable stereoscopic viewing with the naked eye have been developed.

### BRIEF DESCRIPTION OF THE DRAWINGS

FIG. 1 is a cross-sectional view schematically showing a configuration example of a display device.

FIG. 2 shows a cross-sectional view of a display device of a comparative example.

FIG. 3 is a diagram showing a relationship between light passing through a pixel and a lens in the comparative example.

FIG. 4 is a diagram showing a relationship between the light passing through the pixel and the lens in the comparative example.

FIG. 5 is a diagram showing a relationship between the light passing through the pixel and the lens in the comparative example.

FIG. 6 is a diagram showing an image formed by the light shown in FIG. 3.

FIG. 7 is a diagram showing an image formed by the light shown in FIG. 4.

FIG. 8 is a diagram showing an image formed by the light shown in FIG. 5.

FIG. 9 is a diagram showing a relationship between light passing through a pixel and a lens in the embodiment.

FIG. 10 is a diagram showing a relationship between the light passing through the pixel and the lens in the embodiment.

FIG. 11 is a diagram showing a relationship between the light passing through the pixel and the lens in the embodiment.

FIG. 12 is a diagram showing an image formed by the light shown in FIG. 9.

FIG. 13 is a diagram showing an image formed by the light shown in FIG. 10.

FIG. 14 is a diagram showing an image formed by the light shown in FIG. 11.

FIG. 15 is a diagram showing a relationship between the lens and the distance of the light-shielding layer.

FIG. 16 is a diagram showing a display device of a comparative example.

FIG. 17 is a cross-sectional view showing a configuration example of the display device in the embodiment.

FIG. 18 is a cross-sectional view showing a configuration example of the display device in the embodiment.

FIG. 19 is a cross-sectional view showing a configuration example of the display device in the embodiment.

FIG. 20 is a cross-sectional view showing a configuration example of the display device in the embodiment.

FIG. 21 is a cross-sectional view showing another configuration example of the display device in the embodiment.

FIG. 22 is a cross-sectional view showing another configuration example of the display device in the embodiment.

FIG. 23 is a cross-sectional view showing another configuration example of the display device in the embodiment.

FIG. 24 is a cross-sectional view showing another configuration example of the display device in the embodiment.

FIG. 25 is a cross-sectional view showing another configuration example of the display device in the embodiment.

FIG. 26 is a cross-sectional view showing another configuration example of the display device in the embodiment.

FIG. 27 is a diagram showing a relationship between lengths of the lens and an aperture.

FIG. 28 is a diagram showing a relationship between the length (diameter) of a microlens and the length (diameter) of the circular aperture.

FIG. 29 is a plan view showing another configuration example of the display device in the embodiment.

FIG. 30 is a plan view showing another configuration example of the display device in the embodiment.

FIG. 31 is a plan view showing another configuration example of the display device in the embodiment.

FIG. 32 is a plan view showing another configuration example of the display device in the embodiment.

FIG. 33 is a plan view showing another configuration example of the display device in the embodiment.

FIG. 34 is a plan view showing another configuration example of the display device in the embodiment.

### DETAILED DESCRIPTION

In general, according to one embodiment, a display device comprises
a lens element including a plurality of lenses;
a barrier element including a plurality of light-shielding layers; and
a display panel, wherein
the lens element is provided between the display panel and the barrier element, and
each of the plurality of light-shielding layers overlaps an end portion of each respective one of the plurality of lenses.

An object of this embodiment is to provide a display device which can prevent the occurrence of multiple images.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90°. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment

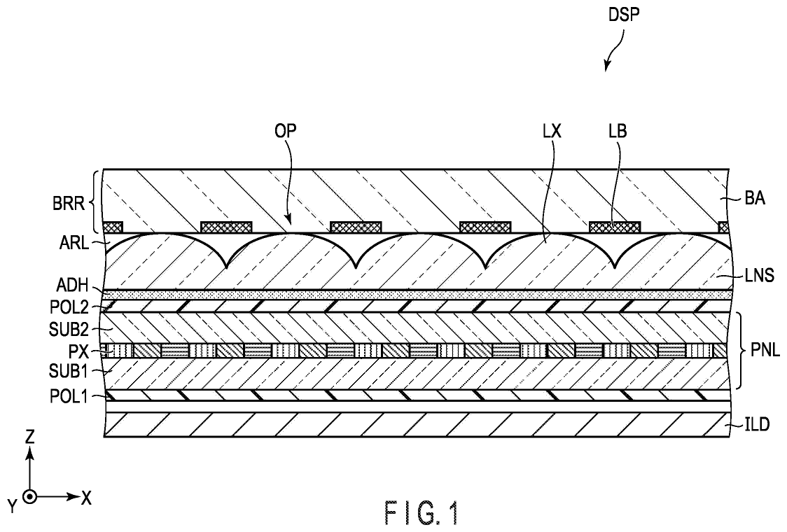

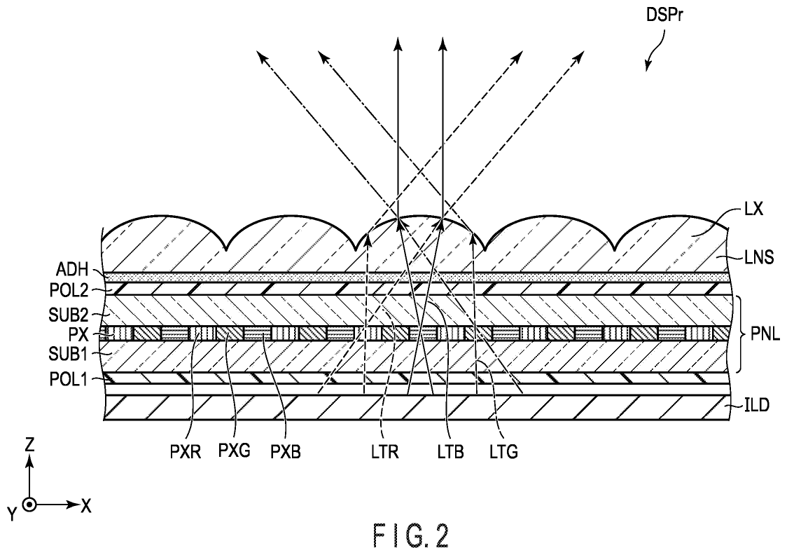

FIG. 1 is a cross-sectional view schematically showing a configuration example of a display device. A display device DSP shown in FIG. 1 comprises an illumination device ILD, a first polarizer POL1, a display panel PNL, a second polarizer POL2, a display panel PNL, an adhesive ADH, a lens element LNS and a barrier element BRR.

The display device DSP is a light field display. When viewing an object, the viewer sees the object when the light reflected from a surface of the object reaches the eyes. On the other hand, a light field display reproduces such reflected light as described above by controlling the emitted light from the display screen showing images. In other words, even in the case of an image of an object displayed on a flat-panel display, reflected light similar to that emitted from the actual object in each direction can be reproduced from emission light from the display screen. With this mechanism, the viewer looking at the display screen feels as if the object is real at one or more viewpoints with respect to the display screen.

Generally, displays achieve a wide viewing angle by diffusing the same light (luminance and color) in all directions as much as possible. On the other hand, light field displays achieve stereoscopic viewing by limiting the direction of light extraction for each pixel. In order to limit the extraction direction of light, for example, the angle of light is limited by a light-shielding barrier or the diffused light is made parallel by a lens. The display device DSP of the embodiment uses a lens to limit the extraction direction of light.

The illumination device ILD can be, for example, a backlight comprising a light source element, a light guide and a diffuser plate. The optical element can be, for example, a light emitting diode (LED), a laser diode or the like. Further, in addition to the light guide and diffusion plate, other optical elements may as well be provided.

The display panel PNL comprises a first substrate SUB1, a second substrate SUB2, a liquid crystal layer (not shown) provided between the first substrate SUB1 and the second substrate SUB2, a polarizer POL1, and a polarizer POL2. The first substrate SUB1 is provided with a plurality of pixel circuits that drive the liquid crystal layer. The second substrate SUB2 or the first substrate SUB1 is provided with a plurality of color filters. The plurality of pixel circuits, the liquid crystal layer and a plurality of color filters constitute a plurality of respective pixels PX. The plurality of pixels PX include pixels PXR emitting a red color, pixels PXG emitting a green color and pixels PXB emitting a blue color. Each pixel PXR, each pixel PXG and each pixel PXB are arranged in this order along the first direction X. The display panel PNL is disposed between the first polarizer POL1 and the second polarizer POL2.

The lens element LNS is adhered to the display panel PNL by the adhesive ADH. The lens element LNS of the embodiment includes a plurality of lenses LX. The lens element LNS can be formed using a transparent material, for example, a transparent resin material. An example of the transparent resin material is acrylic resin. The lens elements LNS may as well be formed using a transparent member that does not change the phase difference of the light that passes therethrough, for example, a glass material. It is also possible to employ a liquid crystal lens as the lens element LNS. In this embodiment, each of the plurality of lenses LX is a lenticular lens. The lenses LX each has a lens shape in the X-Z plane and are extended along the second direction Y.

In the display device DSP of this embodiment, the extraction direction of image light emitted from the pixels PX is limited by the lens element LNS. The lenses LX of the lens element LNS do not shield the video light and the extracted light can be used efficiently. With this configuration, it is possible to obtain a display device with high brightness.

The barrier element BRR is provided on the lens element LNS while interposing an air layer ARL therebetween. The barrier element BRR comprises a base BA and a plurality of light-shielding layers LB. Each of the plurality of light-shielding layers LB is provided to overlap between vertices of the plurality of lenses LX. In other words, the light-shielding layers LB are provided to overlap an end portion of one lens LX. The area between each adjacent pair of light-shielding layers LB is defined as an aperture OP.

The lens element LNS is provided above the display panel PNL. The barrier element BRR is provided above the lens element LNS. In other words, the lens element LNS is provided between the display panel PNL and the barrier element BRR.

The base BA can be a transparent base, for example, a glass base or a base using the transparent resin material described above. The light-shielding layer LB can be, for example, a metal material layer containing chromium (Cr), molybdenum (Mo) or silver (Ag), or a black resin material layer. The light-shielding layer LB is provided on the surface of the base BA.

Illumination light emitted from the illumination device ILD enters the display panel PNL. The display panel PNL displays images by modulating the entering illumination light by the pixels PX of the display panel PNL. The displayed images are emitted upward as an image light and adjusted into parallel light by the lens element LNS.

FIG. 12 shows a cross-sectional view of a display device of a comparative example. The display device DSPr of the comparative example is different from the display device DSP shown in FIG. 1 in that the barrier element is not provided.

In the display device DSPr, for example, it is assumed that the center of one lens LX opposes one green pixel PXG. In other words, the center of the lens LX is located directly above the pixel PXG. Along the first direction X, a pixel PXR is located right next to the pixel PXG on the left side and a pixel PXB is located right next to the pixel PXG on the right side.

The light emitted from the illumination device ILD and passing through the pixel PXR, the pixel PXG and the pixel PXB are defined as light LTR, light LTG and light LTB, respectively. The light LTR, the light LTG and the light LTB each spread about ±200 around the axis of the third direction Z (that is, about 40° in total) when passing through the pixel PXR, the pixel PXG and the pixel PXB, respectively. The lens LX concentrates the spread light and emits it as parallel light. The light LTG passes through the pixel PXG, is concentrated by the lens LX, and is emitted from the lens LX as parallel light. The light LTR passes through the next pixel PXR on the left, is concentrated by the lens LX, and is emitted from the lens LX at an oblique angle upward to the right side of the page. The light LTB passes through the next pixel PXB on the right, is concentrated by the lens LX, and is emitted from the lens LX at an oblique angle to the left on the page.

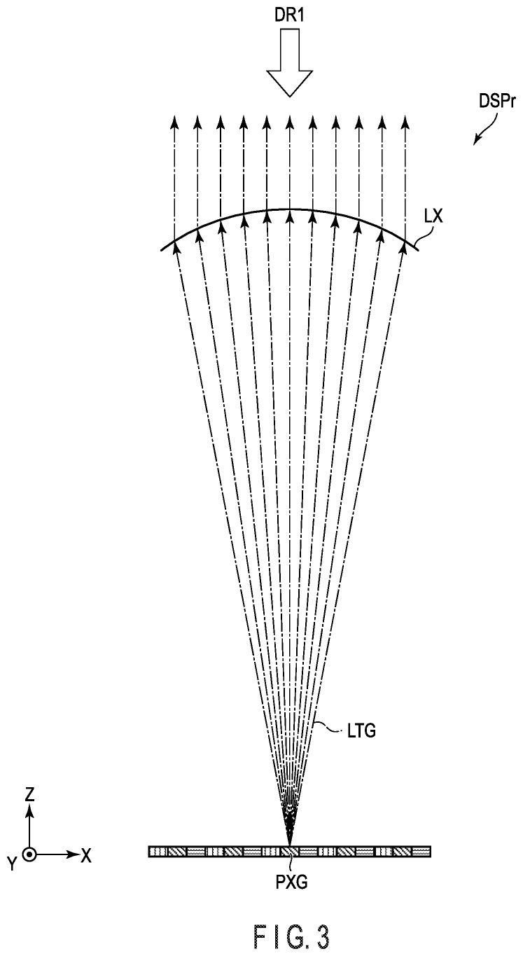

FIG. 3 is a diagram showing a relationship between light passing through a pixel and a lens in a comparative example. In the display device DSPr shown in FIG. 3, light LTG is diffused through the pixel PXG, which emits green light. The diffused light LTG is concentrated when it passes through the lens LX. The concentrated light LTG is emitted from the lens LX as light parallel to the third direction Z. In FIG. 3, the light emitted from the lens LX is entirely light LTG.

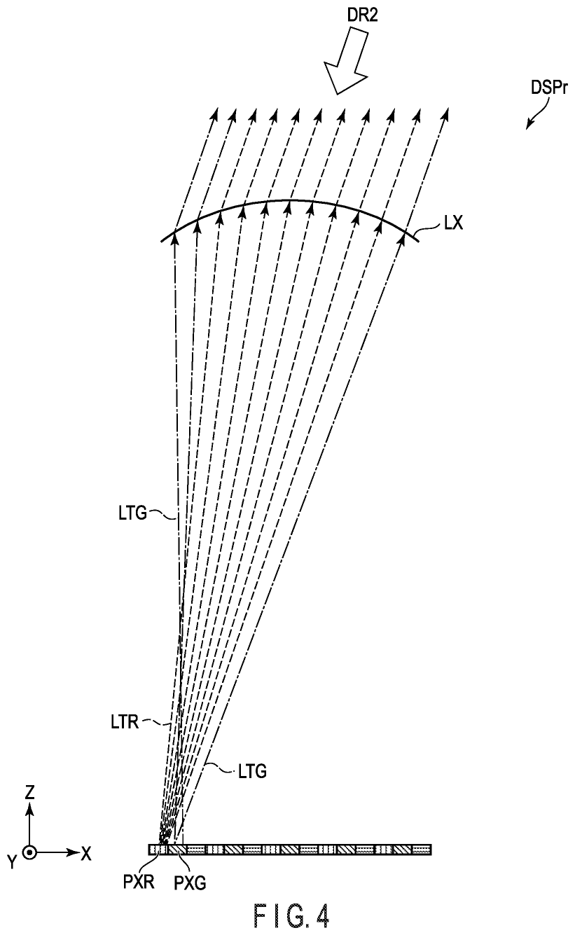

FIG. 4 is a diagram showing a relationship between light passing through a pixel and a lens in a comparative example. In the display device DSPr shown in FIG. 4, the light concentrating position is shifted due to aberrations of the lens LX. In FIG. 4, the relationship between the light passing through the red-emitting pixel PXR and the green-emitting pixel PXG, respectively and the position of the lens LX is shown.

Due to the aberration of the lens LX, not only the light LTR passing through the pixel PXR, but also part of the light LTG passing through the adjacent pixel PXG enter the lens LX. Thus, the light emitted from the lens LX is mixed with not only the light passing through the target pixel PX, but also with the light passing through surrounding pixels PX. The image formed from such light becomes a multiple image, as the misalignment of the information results in superposition of images.

In this disclosure, the light passing through the desired pixel is referred to as a main light ray, and the light passing through a neighboring pixel is referred to as a neighboring light ray. For example, in the example shown in FIG. 4, the light LTR passing through the pixel PXR is the main light ray and the light LTG passing through the pixel PXG is the neighboring light ray. As the proportion of neighboring light rays increases, or in other words, as the proportion of main light rays decreases, the image shift will increase.

The image constituted by only the main light rays switches as the image viewing angle changes, which may reduce the reality of the image. When neighboring light rays are mixed with the main light rays at an appropriate degree and the ratio of the main light rays and neighboring light rays changes gradually, the change in the image is perceived as natural. Thus, it is preferable that neighboring light rays be mixed in to some extent. However, as described above, since the main light rays spread in the direction normal to the pixel (the third direction Z), it becomes necessary to suppress the increase in the ratio of the neighboring light rays to the main light rays.

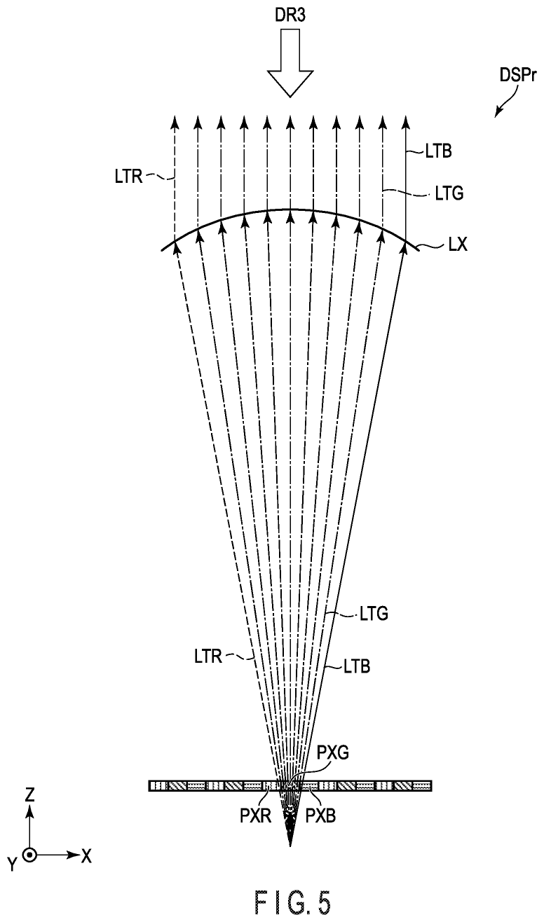

FIG. 5 is a diagram showing a relationship between the light passing through the pixel and the lens in a comparative example. In the display device DSPr shown in FIG. 5, the distance between the pixel and the lens is short due to manufacturing variations. In FIG. 5, the center of the lens LX is located directly above the pixel PXG, which emits green light.

Here, since the distance between the pixel PX and the lens LX is short, not only the light LTG passing through the pixel PXG, but also the light LTR and the light LTB passing through the pixel PXR and pixel PXB adjacent to each other enter the lens LX. Thus, not only the light passing through the target pixel PX, but also the light passing through the surrounding pixels PX are mixed. The image formed from such light becomes a multiple image.

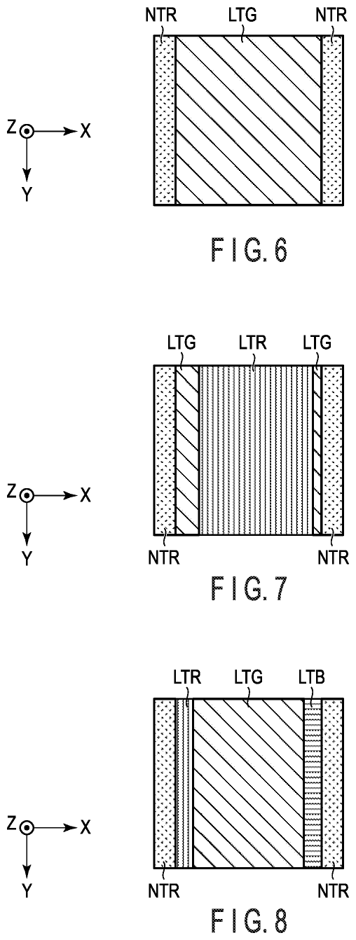

FIGS. 6 to 8 are diagrams each showing an image formed by the light shown in FIGS. 3 to 5, respectively. FIG. 6 is a diagram showing the image viewed from the direction DR1 in FIG. 3. The image shown in FIG. 6 includes an image constituted only by the light LTG concentrated by the lens LX. An end portion of the image formed by the light LTG becomes a non-transmission region NTR where no light reaches.

FIG. 7 shows an image viewed from the direction DR2 in FIG. 4. The image shown in FIG. 7 includes an image formed by the light LTR. To the left and right of the image, an image is formed from the light LTG. As shown in FIG. 4, the light LTG travels from left to right on the page. In FIG. 7, of the images formed by the light LTG on both sides of the image by the light LTR, the width of the image on the right side is greater than the width of the image on the left side.

FIG. 8 shows an image viewed from the direction DR3 in FIG. 5. The image shown in FIG. 8 includes an image constituted by the light LTG. On the left and right sides of the image, images formed by the light LTR and light LTB, respectively, are displayed.

As shown in the comparative example, in a display device without a barrier element, light passing through adjacent pixels may be mixed, resulting in multiple images.

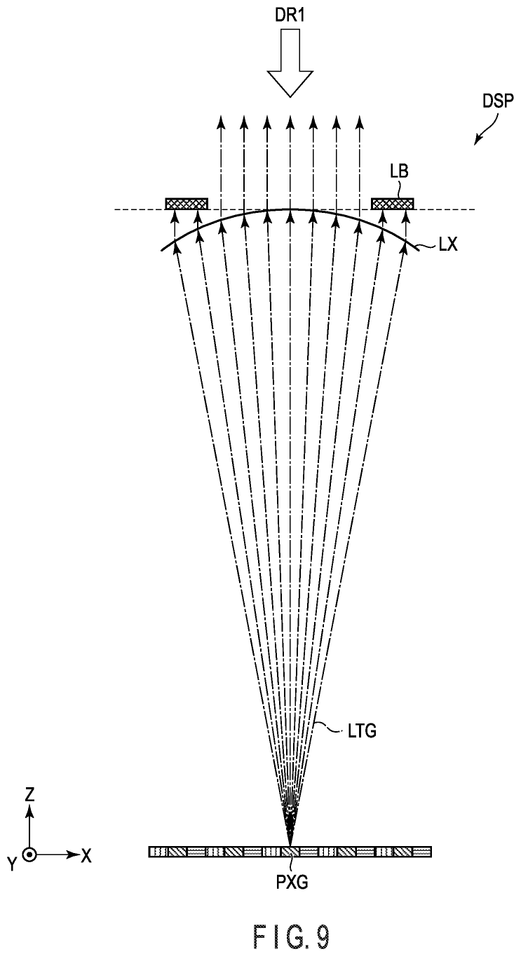

FIGS. 9 to 11 are diagrams each showing the relationship between the light passing to the pixel and the lens in the embodiment. In the display device DSP shown in FIG. 9, a light-shielding layer LB is provided adjacent to the lens LX along the third direction Z. The light-shielding layer LB is provided to overlap between the vertices of each respective adjacent pair of the plurality of lenses LX, as described above. In other words, the light-shielding layer LB is provided to overlap end portions of the respective lens LX.

In FIG. 9, the light-shielding layer LB shields the light LTG passing through the end portions of the lens LX.

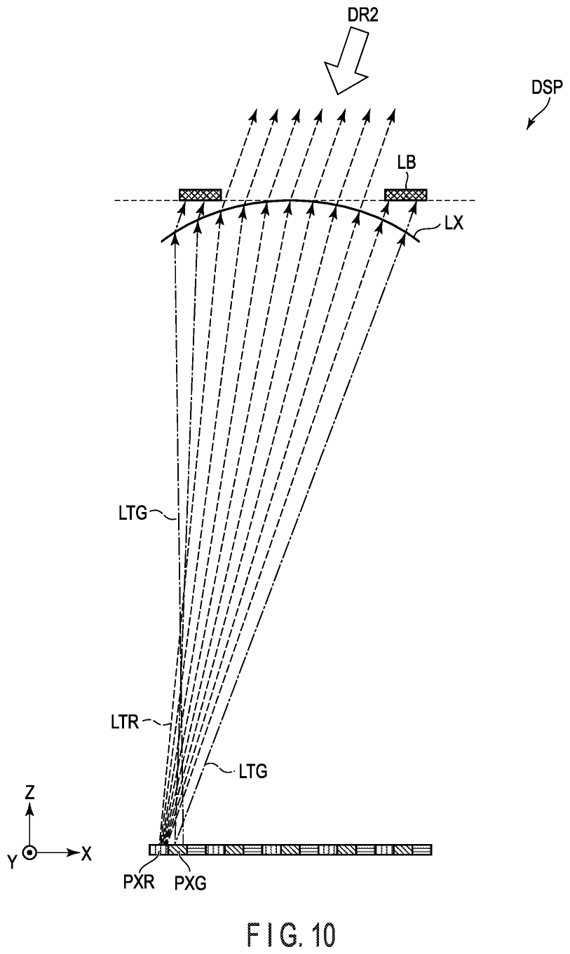

In FIG. 10, the light-shielding layer LB shields part of the light LTG and light LTR passing through the end portions of the lens LX. In the display device DSP shown in FIG. 10, an image constituted only by the light LTR is formed, mixing of light of different colors does not occur. Therefore, it is possible to prevent the generation of multiple images.

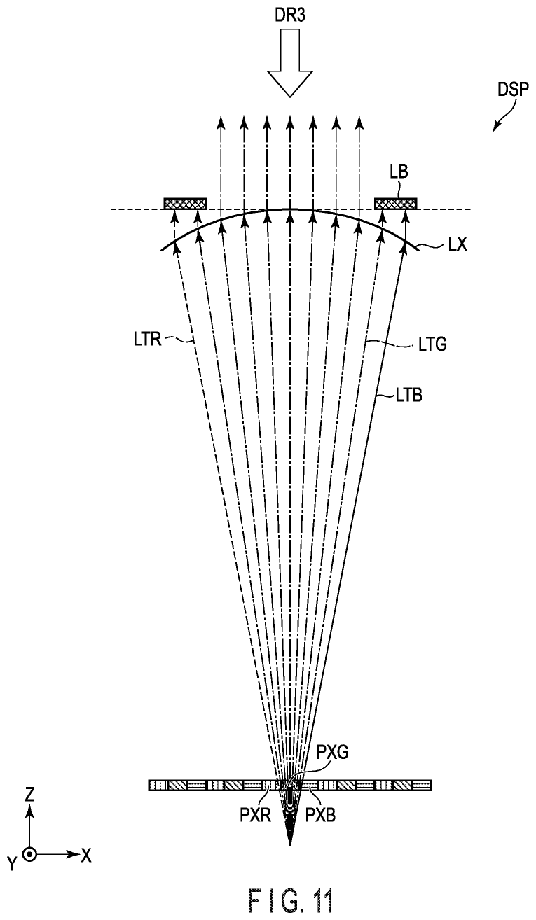

In FIG. 11, the light-shielding layer LB shields the light LTR and light LTB passing through the end portions of the lens LX. By the display device DSP shown in FIG. 11, images constituted only by the light LTG. Thus, in the device of FIG. 11, it is possible to prevent the generation of multiple images.

FIGS. 12 to 14 are diagrams each showing an image formed by the light shown in FIGS. 9 to 11, respectively. In the image shown in FIG. 12, the non-transmission region NTR is covered by the light-shielding layer LB, as compared to the image shown in FIG. 6.

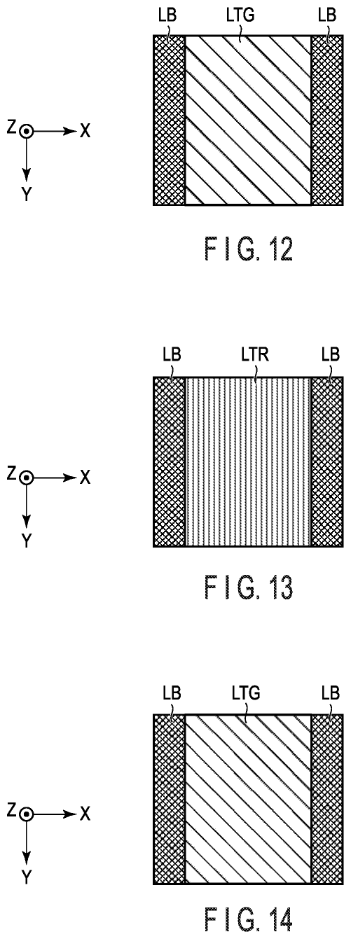

In the image shown in FIG. 13, as compared to the image shown in FIG. 7, the non-transmission region NTR and the region where the light LTG enters the lens LX are covered by the light-shielding layer LB. Therefore, the light LTG does not form an image. To the image formed by the light LTR, color mixing by the light LTG does not occur. Thus, the generation of multiple images can be prevented.

In the image shown in FIG. 14, as compared to the image shown in FIG. 8, the non-transmission region NTR and the region where the light LTR and the light LTB enter the lens LX are covered by the light-shielding layer LB. Therefore, the light LTR and the light LTB do not form an image. To the image formed by the light LTG, color mixing due to the light LTR and the light LTB does not occur. Therefore, the generation of multiple images can be prevented.

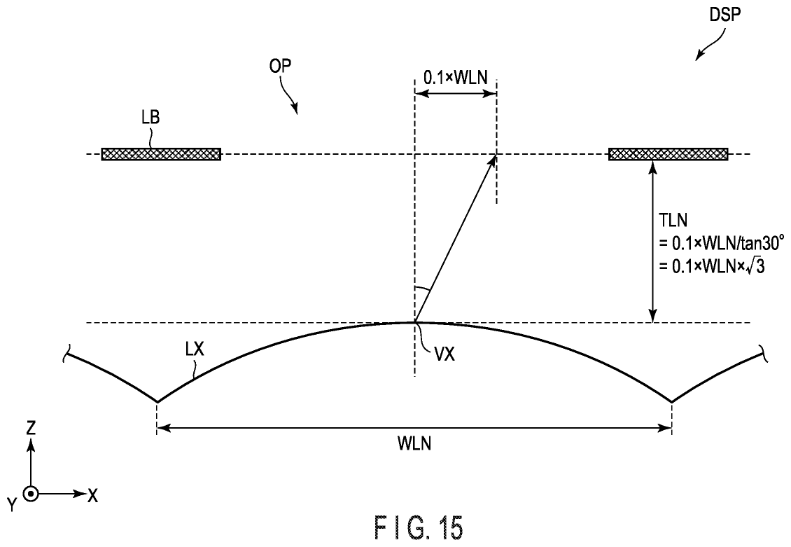

FIG. 15 are diagrams each showing a relationship between the distance between the lens and the light-shielding layer. The width of the lens LX is referred to as a width WLN, the vertex of the lens LX as a vertex VX, and the distance between the X-Y plane containing the vertex VX and the light-shielding layer LB as a distance TLN. Each adjacent pair of light-shielding layers LB are located at the same distant from the vertex VX. In other words, the center of the aperture OP coincides with the normal line passing through the vertex VX (the line along the third direction Z).

As the distance TLN becomes longer, that is, the distance between the lens LX and the light-shielding layers LB is further away from each other, the light in the oblique direction is asymmetrically shielded as viewed from the vertex VX, and the ratio of the main light rays is lowered. In order to limit this, the distance TLN should be greater than or equal to 0, and less than or equal to ((0.1×width WLN/tan 30°)=(0.1×width WLN×√3)) (0≤TLN≤0.1×WLN×43 (Formula 1)).

The distance TLN shown in (Formula 1) is the range where the viewing angle remains at its maximum even if the position of the lens LX is shifted by 10% of the length of the width WLN. The maximum viewing angle is defined as the case where the light emitted from the vertex VX of the lens LX is ±30° with respect to the normal line passing through the vertex VX.

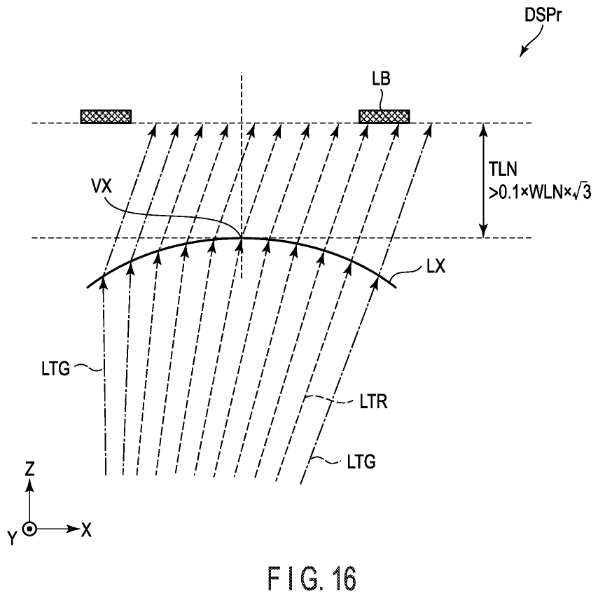

FIG. 16 is a diagram showing a display device of a comparative example. The display device DSPr illustrates the case in the display device DSP shown in FIG. 10, where the distance TLN exceeds 0.1×WLN× √3 (TLN>0.1×WLN×√3).

In the display device DSPr shown in FIG. 16, the light LTG on the left side of the page is not shielded by the light-shielding layer LB. Further, the light LTG on the right side of the page is not shielded by the light-shielding layer LB and also the light LTR, which is the main light rays, is shielded by the light-shielding layer LB. Thus, the light emitted from the display unit DSPr is mixed with the light LTG, which should be unnecessary, and part of the light LTR, which is the main light rays, is shielded, resulting in lowering of the ratio.

Therefore, the distance TLN between the X-Y plane including the vertex VX of the lens LX and the light-shielding layer LB should preferably be the distance that satisfies Formula 1.

The display device DSP of this embodiment comprises a barrier element BRR on the lens element LNS. The display device DSP shields the light passing through adjacent pixels PX by the light-shielding layer LB of the barrier element BRR, and thus can emit only the light passing through the target pixel PX. With this configuration, it is possible to prevent images displayed by the display device DSP from becoming multiple images.

### Configuration Example 1

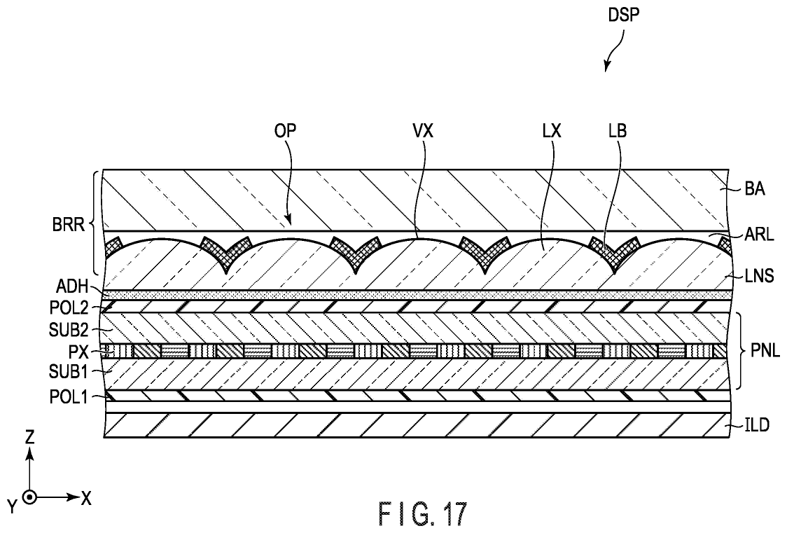

FIG. 17 is a cross-sectional view of another configuration example of the display device in the embodiment. The configuration example shown in FIG. 17 is different from that of FIG. 1 in that the light-shielding layer is provided directly above the lens.

In the display device DSP shown in FIG. 17, the light-shielding layer LB is provided in contact with the surface of the lens LX. The light-shielding layer LB is provided around an end portion of the lens LX, but not around a vertex VX of the lens LX. In other words, an aperture OP is provided around the vertex VX of the lens LX.

The light-shielding layer LB can be, for example, a black resin material layer provided on the surface of the lens LX. Alternatively, if a metal material layer can be formed on the surface of the lens LX, it may as well be a metal material layer containing, for example, chromium (Cr), molybdenum (Mo), silver (Ag) or the like as in the case described above.

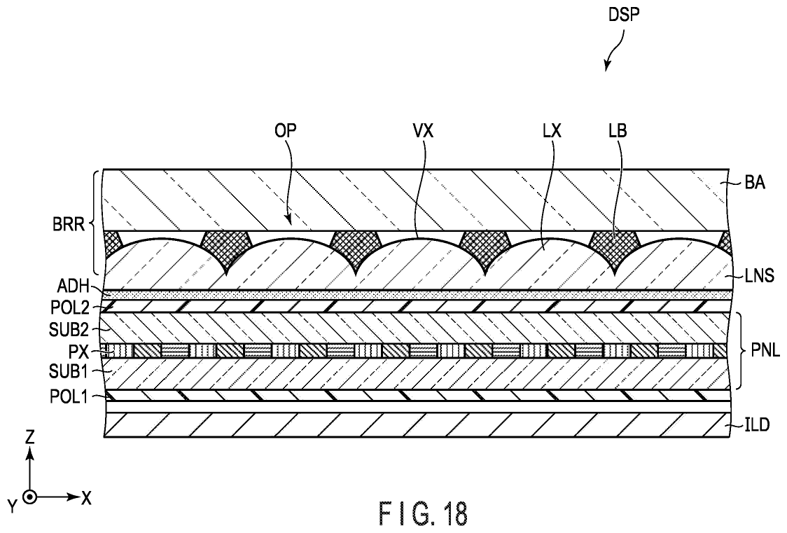

FIG. 18 is a cross-sectional view showing another configuration example of the display device in the embodiment. The configuration example shown in FIG. 18 is different from that of FIG. 17 in that the light-shielding layer is provided between the lens and the base.

In the display device DSP shown in FIG. 18, the bottom surface of the light-shielding layer LB is provided in contact with the surface of the lens LX. The upper surface of the light-shielding layer LB is in contact with the bottom surface of the base BA. As in the case shown in FIG. 17, the light-shielding layer LB is provided around an end portion of the lens LX, but not around the vertex VX of the lens LX.

The light-shielding layer LB shown in FIG. 18 can be, for example, a black resin material layer, an adhesive layer containing black pigment or the like. The light-shielding layer LB may be used to adhere the lens LX and the base BA together.

In this configuration example, advantageous effects similar to those of the embodiment can be achieved.

### Configuration Example 2

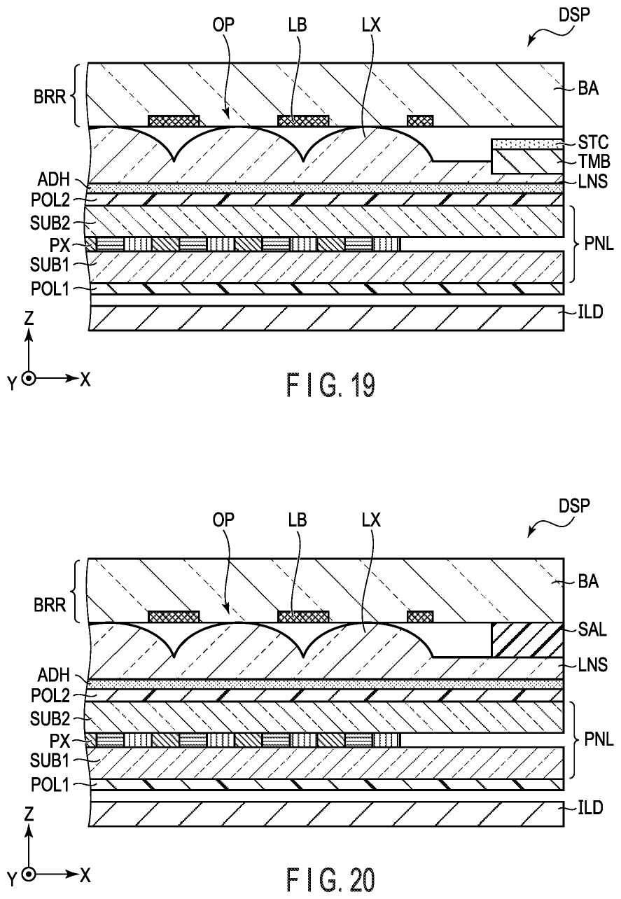

FIG. 19 is a cross-sectional view showing another configuration example of the display device in the embodiment. The configuration example shown in FIG. 19 is an example of the configuration of the end portions of the lens element and the barrier element.

In the display device DSP shown in FIG. 19, a transparent member TMB is provided in contact with the end portion of the lens element LNS. The transparent member TMB is simultaneously mold-formed from the same material as that of the lens LX. An adhesive STC is provided in contact with the transparent member TMB, and the adhesive STC is adhered to the end portion of the base BA of the barrier element BRR.

FIG. 20 is a cross-sectional view showing another configuration example of the display device in the embodiment. The configuration example shown in FIG. 20 is different from that of FIG. 19 in that a sealing member is provided at the end portions of the lens element and the barrier element.

In the display device DSP shown in FIG. 20, a sealing member SAL is provided between the end portion of the lens element LNS and the end portion of the base BA of the barrier element BRR. For the sealing member SAL, for example, a light-curing resin, a heat-curing resin or the like can be used.

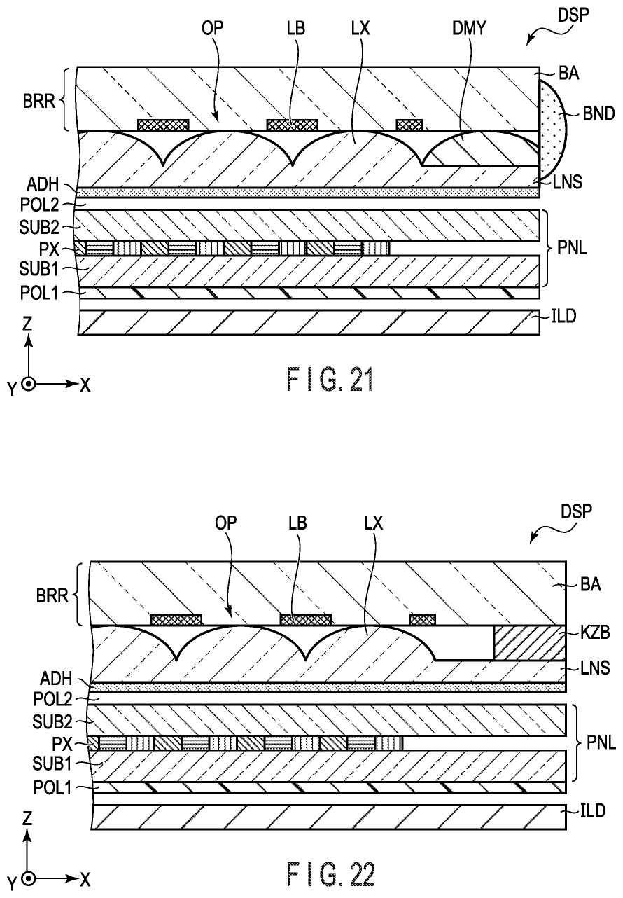

FIG. 21 is a cross-sectional view showing another configuration example of the display device in the embodiment. The configuration example shown in FIG. 21 is different from that of FIG. 19 in that a dummy lens is provided at end portions of the lens element and the barrier element.

In the display device DSP shown in FIG. 21, a dummy lens DMY is provided in contact with an end portion of the lens element LNS. The dummy lens DMY is formed at the same time from the same material as those of the lenses LX. The dummy lens DMY may as well be formed to be integrated with the lens element LNS. With the dummy lens DMY, it is possible to maintain the distance between the lens element LNS and the barrier element BRR.

An adhesive BND is provided on an outer side the end portion of the base BA for the lens element LNS and the barrier element BRR, to adhere the lens element LNS and the base BA together. The adhesive BND should be provided around the periphery of the lens element LNS and the base BA.

FIG. 22 is a cross-sectional view showing another configuration example of the display device in the embodiment. The configuration example shown in FIG. 22 is different from that of FIG. 19 in that a structure is provided at an end portion of the barrier element.

In the display device DSP of FIG. 22, a structure KZB is provided in contact with the base BA of the barrier element BRR. The structure KZB should be, for example, a stacked layered body of double-sided tape, glass sheet and adhesive, or a material obtained by curing bead glass with a UV-curing resin, or the like. The structure KZB is provided between the planarized portion of the lens element LNS and the base BA. With the structure KZB, it is possible to maintain the distance between the lens element LNS and the barrier element BRR.

In this configuration example, advantageous effects similar to those of the embodiment can be achieved.

### Configuration Example 3

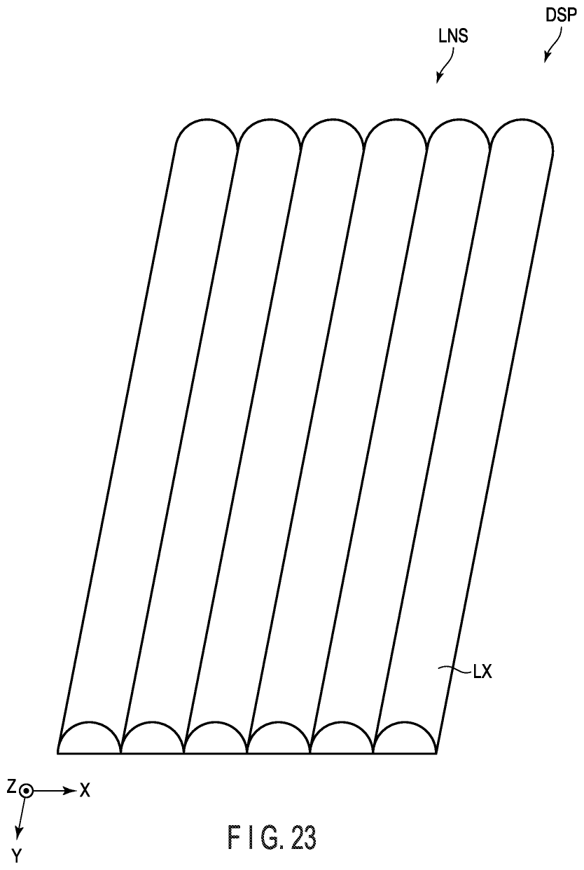

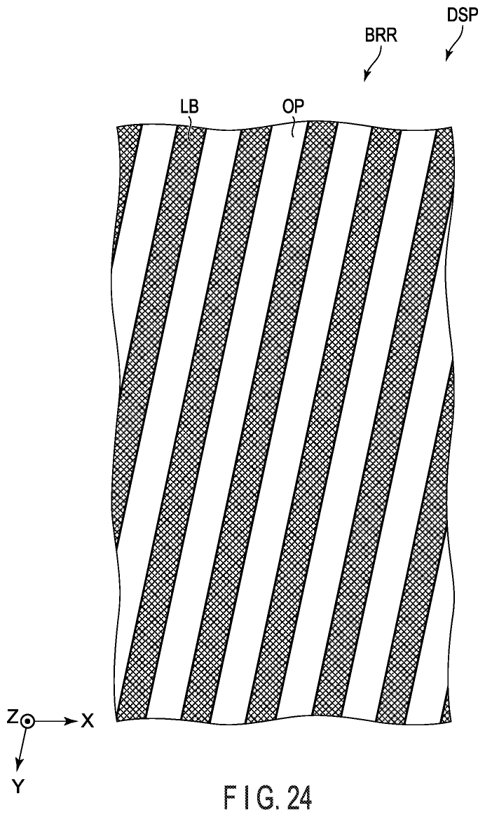

FIGS. 23 and 24 are cross-sectional views of still another configuration example of the display device in the embodiment. The configuration example shown in FIGS. 23 and 24 illustrate an example of the shape of each of the lens element and the barrier element.

The lens element LNS shown in FIG. 23 includes a plurality of lenticular lenses as the lens LX. The lenticular lenses each have a cross-sectional shape along the X-Z plane that is a part of a circle and a rectangular cross-sectional shape along the Y-Z plane. The lenticular lenses extend along the second direction Y.

In the barrier element BRR shown in FIG. 24, light-shielding layers LB are formed. The portion where the light-shielding layers LB are not formed is an aperture OP. The aperture OP includes a plurality of slits. Each of the slits extends along the second direction Y as in the case of the lenticular lenses.

Each of the slits is located to overlap each respective one of the plurality of lenticular lenses in plan view. The width of the slits is less than the width of the lenticular lenses.

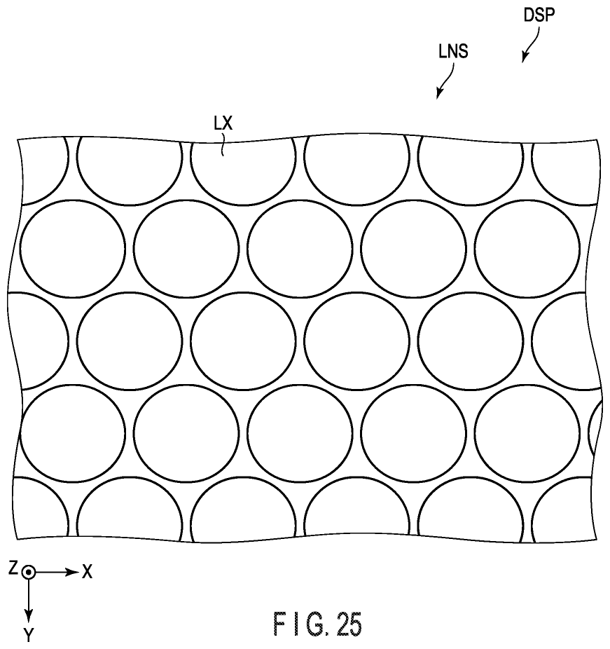

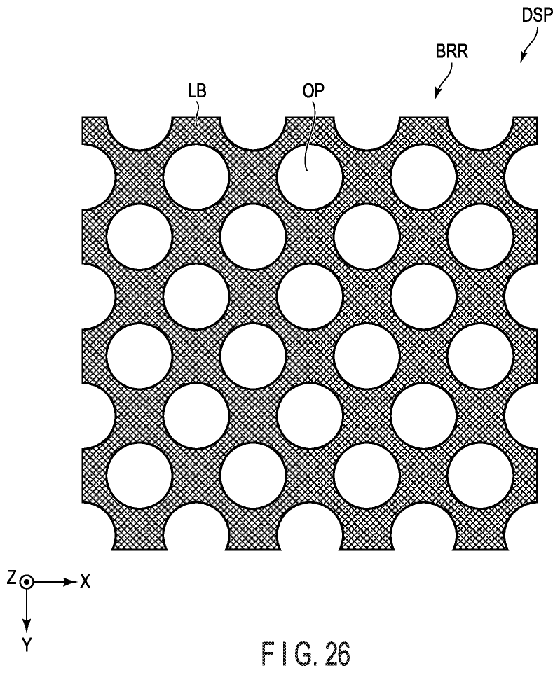

FIGS. 25 and 26 are cross-sectional views each showing still another configuration examples of the display device in the embodiment. The configuration example shown in FIGS. 25 and 26 is different from that of FIGS. 23 and 24 in that the lens element and barrier element are circular in shape.

The lens element LNS shown in FIG. 25 includes a plurality of microlenses as lenses LX. Each of the plurality of microlenses has a hemispherical shape. The cross section of the microlenses in the X-Z plane as well is a semicircular shape when taken along the Y-Z plane. The cross section of the microlenses in the X-Y plane is circular in shape.

The barrier element BRR shown in FIG. 26 includes a light-shielding layer LB formed. The portions where the light-shielding layer LB is not formed are apertures OP. The apertures OP constitute a plurality of circular apertures.

Each of the circular-shaped apertures is provided to overlap each respective one of the plurality of microlenses in plan view. The diameter of the circular-shaped apertures is less than the diameter of the microlenses.

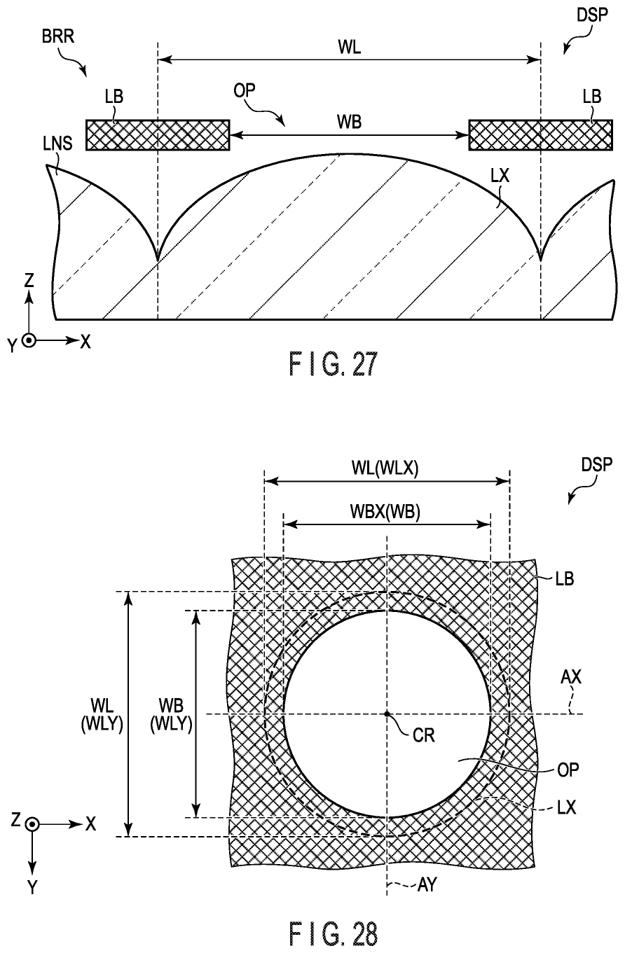

FIG. 27 is a diagram showing a relationship between the lenses and apertures in length. FIG. 27 is a partially enlarged view of FIG. 1, showing mainly the lens LX and the aperture OP. The lens LX should only be a lenticular lens shown in FIG. 23 or a microlens shown in FIG. 25. The aperture OP should be a slit as shown in FIG. 24, a circular shaped aperture as shown in FIG. 25, or the like.

In FIG. 27, the length (width) of the aperture OP along the first direction X is referred to as WB and the length (width) of the lens LX along the first direction X is referred to as WL. As mentioned above, the length WB is less than the length WL (WB<WL). Note that the length WB in FIG. 17, when the lens LX is a lenticular lens, corresponds to the width WLN described above.

Further, the length WB should preferably be 50% or more of the length WL (WB≥0.5×WL). By setting the length WB to 50% or more of the length WL, the depth of field of the lens element LNS can be increased.

FIG. 28 is a diagram showing a relationship between the length (diameter) of the microlens and the length (diameter) of the circular shaped aperture.

It is preferable that the center of the microlens and the center of the circular-shaped aperture should coincide with each other. In the example shown in FIG. 28, the center of the microlens and the center of the circular-shaped aperture are both at the center CR. The distance from the end portion of the circular-shaped aperture to the end portion of the microlens is equal in all directions.

In FIG. 28, the length of the lens LX, which is a microlens, along the first direction X is referred to as a length WLX, and the length thereof along the second direction Y is referred to as a length WLY. The length of the aperture OP, which is a circular shaped aperture, along the first direction X is referred to as a length WBX, and the length thereof along the second direction Y is referred to as a length WBY.

In each of the first direction X and the second direction Y, the length WBX should preferably be 50% or more of the length WLX (WBX≥0.5×WLX), as in the case described above. The length WBY should preferably be 50% or more of the length WLY (WBY≥0.5×WLY). With this configuration, it is possible to increase the depth of field of the lens element LNS.

When the shape of the microlens in plan view is a perfect circle, the length WLX and the length WLY are equal to each other (WLX=WLY). When the shape of the circular aperture in plan view is a perfect circle, the length WBX and the length WBY are equal to each other (WBX=WBY). However, even if the shape of the microlens and the circular aperture in plan view is not a perfect circle, the length of the aperture OP should be 50% or more of the length of the lens LX in each of the first direction X and the second direction Y.

In this configuration example, advantageous effects similar to those of the embodiment can be achieved.

### Configuration Example 4

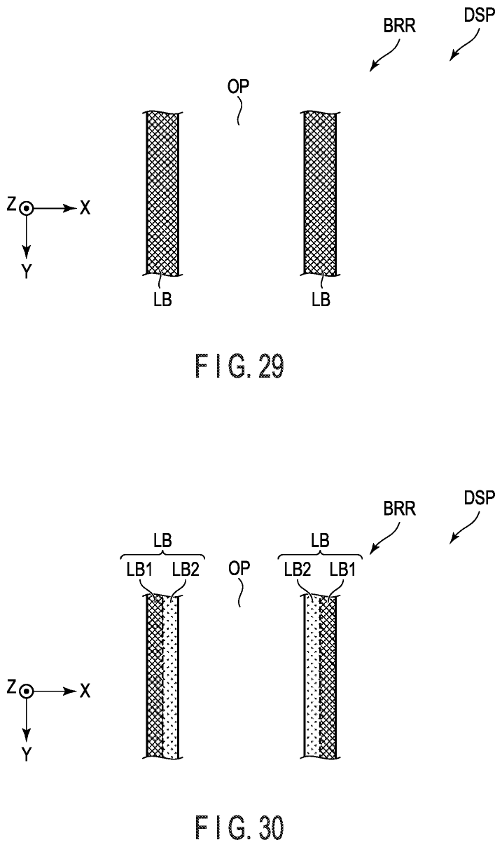

FIG. 29 is a plan view showing another configuration example of the display device in the embodiment. The configuration example shown in FIG. 29 is an example of the shape of the barrier element.

The barrier element BRR shown in FIG. 29 include light-shielding layers LB, and the region where the light-shielding layers LB are not provided is an aperture OP. In the barrier element BRR shown in FIG. 29, the aperture OP includes a plurality of slits as in the case of FIG. 24.

FIG. 30 is a plan view showing another configuration example of the display device in the embodiment. The configuration example shown in FIG. 30 is different from that of FIG. 29 in that boundary regions of the light-shielding layers adjacent to each aperture are each halftone processed.

In FIG. 30, the light-shielding layers LB each include a region LB2 directly adjacent to the aperture OP and a region LB1 not directly adjacent to the aperture OP. Thus, the region LB2 is provided between the aperture OP and the region LB1. The region LB1 and the region LB2 may as well be referred to as the first and second regions, respectively.

The region LB2 is halftone processed and has a transmittance higher than that of the region LB1. Including the case where the region LB2 is halftone processed, it is preferable that the transmittance of the region LB2 and the aperture OP for one lens LX should be 50% or more.

In the region LB2, the halftone processing may be performed uniformly or in steps. In other words, the transmittance in the region LB2 may be constant or varies in steps. When the transmittance of the region LB2 is variable in steps, the transmittance should increase as the location approaches the aperture OP. The following is an example of a stepwise variation in the transmittance of the region LB2.

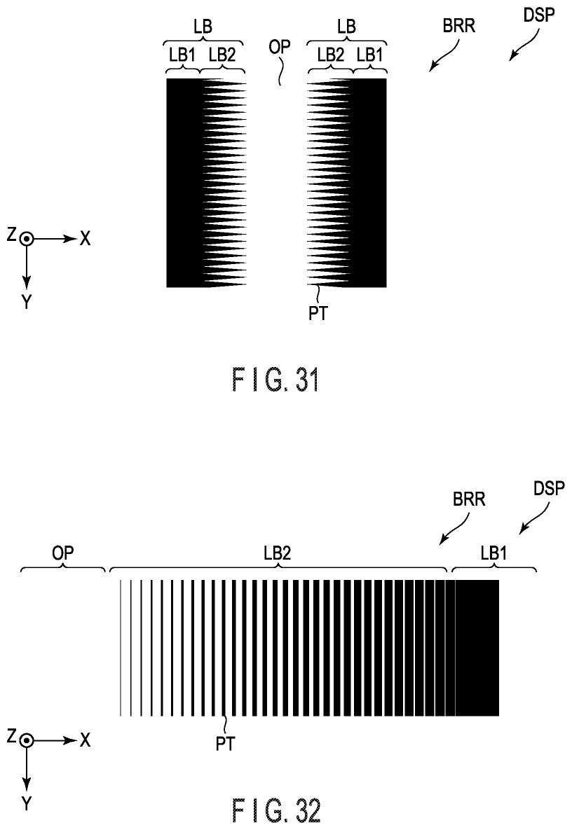

FIG. 31 is a plan view showing another configuration example of the display device in the embodiment. The configuration example shown in FIG. 31 is different from that of FIG. 29 in that the boundary region of the light-shielding layer adjacent to the aperture has such a pattern that the transmittance varies in stages. The display device DSP shown in FIG. 31 is an example of the display device DSP shown in FIG. 30.

In FIG. 31, the light-shielding layers LB each include a region LB2 directly adjacent to the aperture OP and a region LB1 not directly adjacent to the aperture OP. The region LB2 is provided between the aperture OP and the region LB1.

The regions LB2 each include a plurality of triangular light-shielding patterns PT extending from the respective region LB1 along the first direction X. Each of the plurality of triangular light-shielding patterns PT decreases its length (width) along the second direction Y as the location approaches the aperture OP.

The distance between each adjacent pair of light-shielding patterns PT is defined as the pitch of the light-shielding patterns PT. It is preferable that the pitch of the light-shielding pattern PT be less than or equal to the pitch of the pixels PX. With this configuration, it is possible to prevent the light-shielding pattern PT from being visible. In the case shown in FIG. 31 as well, the transmittance of the region LB2 and the aperture OP for one lens LX should preferably be 50% or more.

FIG. 32 is a plan view showing another configuration example of the display device in the embodiment. The configuration example shown in FIG. 32 is different from that of FIG. 31 in that the pattern has a shape of stripes with varied widths. The display device DSP shown in FIG. 32 is an example of the display device DSP shown in FIG. 30.

The region LB2 shown in FIG. 32 includes a plurality of stripe-shaped light-shielding patterns PT extending along the first direction X. The plurality of stripe-shaped light-shielding patterns PT are disposed side by side along the first direction X. The length (width) of each of the plurality of stripe-shaped light-shielding patterns PT along the first direction X becomes shorter as it approaches the aperture OP. The width of each of the light-shielding patterns PT becomes longer as it approaches the region LB1.

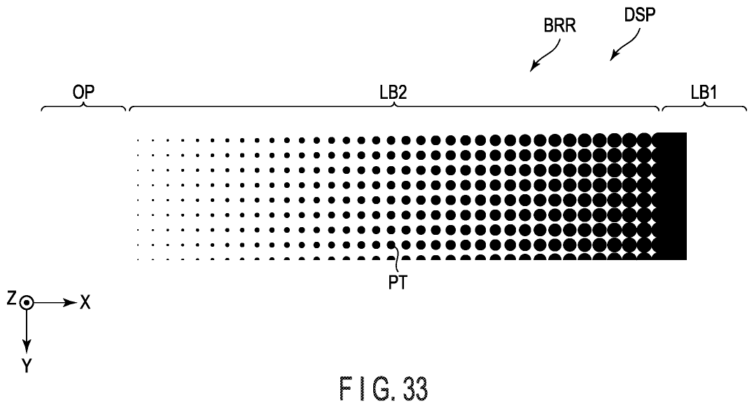

FIG. 33 is a plan view showing another configuration example of the display device in the embodiment. The configuration example shown in FIG. 33 is different from that of FIG. 31 in that the pattern is based on circles and the diameter of the pattern varies. The display device DSP shown in FIG. 33 is an example of the display device DSP shown in FIG. 30.

The region LB2 shown in FIG. 33 includes a plurality of circular light-shielding patterns PT. The pitch of the plurality of circular light-shielding patterns PT is constant all over the region LB2. The circular light-shielding patterns PT are arranged so that the diameter is smaller as the location one respective pattern approaches the aperture OP, whereas it is greater as the location approaches the region LB1.

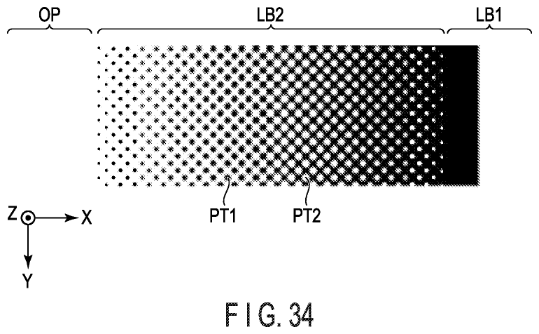

FIG. 34 is a plan view showing another configuration example of the display device in the embodiment. The configuration example shown in FIG. 34 is different from that of FIG. 33 in that the diameters of the aperture patterns are varied from one another as in the case of the light-shielding patterns. The display device DSP shown in FIG. 34 is an example of the display device DSP shown in FIG. 30.

The region LB2 shown in FIG. 34 include light-shielding patterns PT1 formed by a light-shielding material and aperture patterns PT2, which are the region where no light-shielding material is provided. The light-shielding patterns PT1 are the same as the light-shielding patterns PT shown in FIGS. 31 to 33.

The plurality of light-shielding patterns PT1 are a circular patterns. The pitch of the light-shielding patterns PT1 is constant within the entire region LB2. The light-shielding patterns PT are arranged so that the diameter is smaller as the location one respective pattern approaches the aperture OP, whereas it is greater as the location approaches the region LB1.

The plurality of aperture patterns PT2 are circular patterns. The pitch of the aperture patterns PT2 is constant within the entire region LB2. The plurality of aperture patterns PT2 are arranged so that the diameter is smaller as the location one respective pattern approaches the aperture OP, whereas it is greater as the location approaches the region LB1.

Each of the plurality of light-shielding patterns PT1 is located adjacent to each respective one of the plurality of aperture patterns PT2. Thus, the plurality of light shielding patterns PT1 and the plurality of aperture patterns PT2 are arranged alternately with respect to each other in both the first direction X and the second direction Y. In other words, the plurality of circular light-shielding patterns are disposed in a staggered arrangement and the plurality of circular aperture patterns are disposed in a staggered arrangement as shown in FIG. 34.

The light-shielding patterns PT1 and the aperture patterns PT2 shown in FIG. 34 are circular patterns, but the invention is not limited to such a shape. For example, the light-shielding patterns PT1 and the aperture patterns PT2 may be polygonal in shape, such as a triangular shape, a quadrangular shape or the like.

The examples shown in FIGS. 31 to 34 are variations of that shown in FIG. 30, in which the transmittance of the region LB2 varies in steps. In the case where the transmittance of the region LB2 is uniform in FIG. 30, the light-shielding patterns PT (including the aperture patterns PT2 in FIG. 34) of the shapes shown in FIGS. 31 to 34, respective, should only be uniformly provided. To cite an example of such, a plurality of circular patterns having the same diameter are provided in the region LB2.

In this configuration example, advantageous effects similar to those of the embodiment can be exhibited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a lens element including a plurality of lenses;
a barrier element including a plurality of light-shielding layers; and
a display panel, wherein
the lens element is provided between the display panel and the barrier element, and
each of the plurality of light-shielding layers overlaps an end portion of each respective one of the plurality of lenses.

2. The display device according to claim 1, wherein
the barrier element further comprises a transparent base, and
the plurality of light-shielding layers are provided on a surface of the transparent base.

3. The display device according to claim 1, wherein
each of the plurality of light shielding layers is provided in contact with a surface of each respective one of the plurality of lenses.

4. The display device according to claim 1, wherein
the barrier element further comprises a transparent base, and
each of the light-shielding layers is provided between each respective one of the plurality of lenses and the transparent base.

5. The display device according to claim 1, wherein
when a length of each of the plurality of lenses along the first direction is WLN, and a distance between a plane including a vertex of each of the plurality of lenses and the light-shielding layers is TLN,
the distance TLN satisfies:
0≤TLN≤0.1×WLN×√3.

6. The display device according to claim 1, wherein
a region between each adjacent pair of the plurality of light-shielding layers is an aperture, and
a length of the aperture along the first direction is 50% or more of a length of each of the plurality of lenses along the first direction.

7. The display device according to claim 1, wherein
a region between each adjacent pair of the plurality of light shielding layers is an aperture,
the plurality of lenses are a plurality of lenticular lenses, respectively, and
a plurality of apertures each identical to the aperture are a plurality of slits, respectively.

8. The display device according to claim 1, wherein
a region between each adjacent pair of the plurality of light-shielding layers is an aperture,
the plurality of lenses are a plurality of microlenses, respectively, and
a plurality of apertures each identical to the aperture are a plurality of circular apertures, respectively.

9. The display device according to claim 1, wherein
a region between each adjacent pair of the plurality of light-shielding layers is an aperture,
each of the plurality of light-shielding layers includes a first region and a second region,
the second region is provided between the first region and the aperture, and
the second region has a transmittance higher than that of the first region.

10. The display device according to claim 9, wherein
the transmittance of the second region increases as a location approaches the aperture, the location being in the second region.

11. The display device according to claim 9, wherein
the second region includes a plurality of triangular light-shielding patterns, and
each of the plurality of triangular light-shielding patterns decreases in width as a location approaches the aperture, the location being in the each of the plurality of triangular light-shielding patterns.

12. The display device according to claim 9, wherein
the second region includes a plurality of stripe light-shielding patterns, and
respective widths of the plurality of stripe light-shielding patterns decrease as a location approaches the aperture, the location being provided in the second region and being a location of a corresponding one of the plurality of stripe light-shielding patterns.

13. The display device according to claim 9, wherein
the second region includes a plurality of circular light-shielding patterns, and
respective diameters of the plurality of circular light-shielding patterns decrease as a location is closer to the aperture, the location being provided in the second region and being a location of a corresponding one of the plurality of circular light-shielding patterns.

14. The display device according to claim 9, wherein
the second region includes a plurality of circular light-shielding patterns and a plurality of circular aperture patterns,
respective diameters of the plurality of circular light-shielding patterns decrease as a location is closer to the aperture, the location being provided in the second region and being a location of a corresponding one of the plurality of circular light-shielding patterns,
respective diameters of circular aperture patterns decrease as a location is closer to the first region, the location being provided in the second region and being a location of a corresponding one of the plurality of circular aperture patterns, and
the plurality of circular light-shielding patterns are disposed in a staggered arrangement and the plurality of circular aperture patterns are disposed in a staggered arrangement.

15. The display device according to claim 1, wherein
a transparent member is provided in contact with an end portion of the lens element,
an adhesive is provided in contact with the transparent member,
the adhesive is adhered to an end portion of the barrier element, and
the transparent member is mold-formed from a same material as that of each of the plurality of lenses.

16. The display device according to claim 1, wherein
a sealing member is provided between an end portion of the lens element and an end portion of the barrier element.

17. The display device according to claim 1, wherein
a dummy lens is provided in contact with an end portion of the lens element,
an adhesive is provided on an outer side the end portion of the lens element and an end portion of the barrier element,
the adhesive surrounds and covers a periphery of the lens element and the barrier element, and
the dummy lens is formed at a same time from a same material as those of the plurality of lenses.

18. The display device according to claim 1, wherein
a structure is provided in contact with an end portion of the barrier element, and
the structure is one of a double-sided tape, a stacked body of a glass sheet and an adhesive and beaded glass cured with a IV-curing resin.
